(19) United States
(12) Patent Application Publication
(10) Pub. No.: US 2009/0161106 A1
(43) Pub. Date: Jun. 25, 2009

(54) Wafer lens aligning method and wafer lens manufactured by the same

(75) Inventors: Dong Ik SHIN, Gyeonggi-do (KR); Hyun Jun KIM, Gyeonggi-do (KR); Seok Cheon Lee, Gyeonggi-do (KR); Sun Ok Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD. of Suwon, Republic of Korea

(21) Appl. No.: 12/076,546

(22) Filed: Mar. 19, 2008

(30) Foreign Application Priority Data
Dec. 20, 2007 (KR) 10-2007-0134231

(51) Int. Cl. G01B 11/00

(52) U.S. Cl. 356/399

(57) ABSTRACT

Provided is a wafer lens aligning method including the steps of: preparing a lens mold that has a lens forming portion formed in the central portion thereof and a groove formed around the lens forming portion; preparing a wafer that has two or more position recognition patterns formed at arbitrary positions thereof and a plurality of minute patterns formed in array at lens formation positions; loading the wafer, searching the position recognition patterns, and setting a coordinate system; causing the coordinate system of the wafer to coincide with the coordinate system of the lens mold; causing the center among the minute patterns formed on the wafer to coincide with the center of the lens mold so as to align the wafer with the lens mold; and forming a master lens in the lens formation positions arranged on the wafer.

### CROSS-REFERENCE TO RELATED APPLICATIONS

This application claims the benefit of Korean Patent Application No. 10-2007-0134231 filed with the Korea Intellectual Property Office on Dec. 20, 2007, the disclosure of which is incorporated herein by reference.

### BACKGROUND OF THE INVENTION

1. Field of the Invention

The present invention relates to a wafer lens aligning method and a wafer lens manufactured by the same.

2. Description of the Related Art

In general, a mastering process, a stamping process, an embossing process, and a dicing process are sequentially performed to manufacture a plurality of wafer lenses in the form of single lens.

In this case, polymer which is to be cured by ultraviolet (UV) light is injected into a mold for molding a lens in the mastering process. Further, the polymer is attached on one surface of a substrate-type wafer and is cured by UV irradiation such that a lens is attached to the surface of the wafer. Then, the lens is transferred to the next process.

The wafer lens manufactured through the above-described manufacturing process is managed in accordance with a strict standard tolerance of less than several μm in the respective processes, in order to maintain resolution determined at a design step. Further, the respective lenses are manufactured in an array type in the mastering process. Accordingly, when an error occurs, the error is handed down until a product is finalized through the following process. Therefore, the standard tolerance should be strictly managed.

In such a mastering process, various methods for aligning a wafer with a mold are used to reduce an error occurring between the wafer and the mold. Now, a conventional wafer aligning method will be described as follows.

First, patterns are formed on a wafer at a distance corresponding to the diameter of a mold such that the periphery of the mold is positioned inside the patterns. Then, the alignment between the wafer and the mold is achieved.

In such an aligning method, however, the outer circumferential surface of the mold is not relatively precisely processed, compared with a lens forming portion which is precisely processed. Therefore, alignment accuracy between the wafer and the mold decreases. Then, the wafer lens may be formed in an elliptical shape, or eccentricity may occur.

Further, the alignment between the wafer and the mold may be achieved by driving a motor coupled to the mold, without a pattern formed on the wafer. However, when the mold is attached to and detached from a jig connected to the motor, an assembling error may occur. Further, the mold is inevitably moved by a release impact of the motor which is generated when the lens is molded. Therefore, there are difficulties in aligning the wafer with precision.

To solve such a problem, a method has been disclosed, in which alignment between a wafer and a mold is achieved through Moire fringes formed by overlapping patterns formed in the wafer and the mold.

FIG. 1 is a cross-sectional view of a mold and a wafer when the wafer is aligned by the conventional wafer aligning method. FIGS. 2A and 2B are plan views of Moire fringes emerging when the wafer is aligned by the conventional wafer aligning method.

In the conventional wafer aligning method, a first alignment mark 120 composed of a plurality of grooves is formed around a lens forming portion 110 of a mold 100, and a second alignment mark 130 having shading patterns 241 and 251 corresponding to the first alignment mark 120 is formed on a substrate 200.

At this time, shading patterns are formed on the surface of the substrate 200 through the grooves of the first alignment mark 120 by the light irradiated from above the substrate 200.

FIGS. 2A and 2B are diagrams showing Moire fringes which emerge after the mold 100 and the substrate 200 are aligned by the conventional wafer aligning method. When the mold 100 and the substrate 200 are accurately aligned with each other, concentric Moire fringes emerge as shown in FIG. 2A. Otherwise, when the mold 100 and the substrate 200 are not aligned with each other, Moire fringes are formed as shown in FIG. 2B. Then, an operator checks the Moire fringes with naked eyes so as to judge whether the mold 100 and the substrate 200 are aligned with each other or not.

In such a conventional wafer aligning method, the first alignment mark 120 formed in the mold 100 is accurately processed. However, the operator should judge whether the substrate 200 and the mold 100 are aligned with each other or not. Therefore, there are difficulties in automating the aligning process.

Further, the Moire fringes should be checked through a microscope. In this case, the Moire fringes may differ depending on the magnification and resolution of the microscope. Therefore, there are difficulties in setting operation standards during the wafer aligning.

[Patent Document] Korean Patent No. 10-631989

### SUMMARY OF THE INVENTION

An advantage of the present invention is that it provides a wafer lens aligning method, in which the coordinate system of a wafer is set by position recognition patterns formed at arbitrary positions, a mold is moved in accordance with the set coordinate system, and minute patterns formed in each lens formation position of the wafer are aligned with a groove formed on the mold such that the mold can be accurately aligned with the lens formation position.

Another advantage of the invention is that it provides a wafer lens manufactured by the wafer lens aligning method.

Additional aspects and advantages of the present general inventive concept will be set forth in part in the description which follows and, in part, will be obvious from the description, or may be learned by practice of the general inventive concept.

According to an aspect of the invention, a wafer lens aligning method comprises the steps of: preparing a lens mold that has a lens forming portion formed in the central portion thereof and a groove formed around the lens forming portion; preparing a wafer that has two or more position recognition patterns formed at arbitrary positions thereof and a plurality of minute patterns formed in array at lens formation positions; loading the wafer, searching the position recognition patterns, and setting a coordinate system; causing the coordinate system of the wafer to coincide with the coordinate system of the lens mold; causing the center among the minute patterns formed on the wafer to coincide with the center of the lens mold so as to align the wafer with the lens mold; and forming a master lens in the lens formation positions arranged on the wafer.

Preferably, polymer-based resin for molding a lens is injected into the lens forming portion formed in the central portion of the lens mold, and the mold is closely contacted with the lens formation position of the wafer.

Preferably, the position recognition patterns are formed in a dot shape, a cross shape, or a circular shape.

Preferably, the minute patterns are formed of metal.

Preferably, the minute patterns are formed in a linear shape so as to be spaced at a predetermined distance from the groove, the minute patterns being symmetrical with each other.

Preferably, the minute patterns are formed in a circular arc having an approximate curvature to the circumference of the groove.

According to another aspect of the invention, there is provided a wafer lens manufactured by the wafer lens aligning method according to the above-described aspect.

Preferably, the wafer lens has a projection formed on the surface thereof corresponding to the top surface of the lens mold, the projection being formed by transferring resin into the groove.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view of a mold and a wafer when the wafer is aligned by the conventional wafer aligning method;

FIGS. 2A and 2B are plan views of Moire fringes emerging when the wafer is aligned by the conventional wafer aligning method;

FIG. 3 is a cross-sectional view of a mold which is adopted in a wafer lens aligning method according to the invention;

FIG. 4 is a plan view of the mold of FIG. 3;

FIG. 5 is a plan view of a wafer adopted in the wafer lens aligning method according to the invention;

FIGS. 6A and 6B are schematic views showing a state where minute patterns formed on a wafer and a groove of the lens mold are aligned with each other;

FIG. 7 is a flow chart showing a wafer lens aligning method according to the invention; and

FIG. 8 is a cross-sectional view of a lens manufactured by the wafer lens aligning method according to the invention.

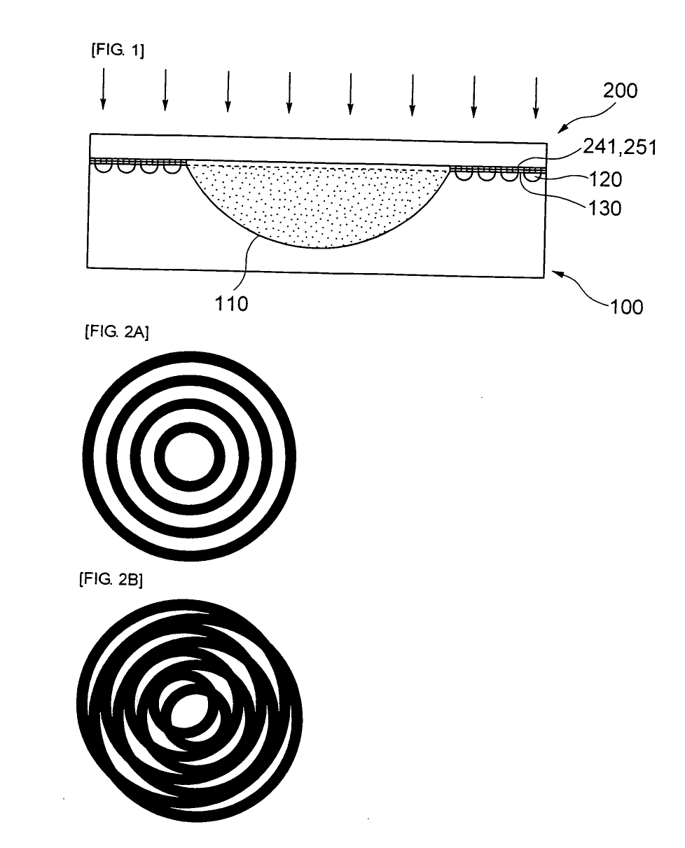

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, a wafer lens aligning method and a wafer lens manufactured by the same according to an embodiment of the present invention will be described in detail with reference to the accompanying drawings.

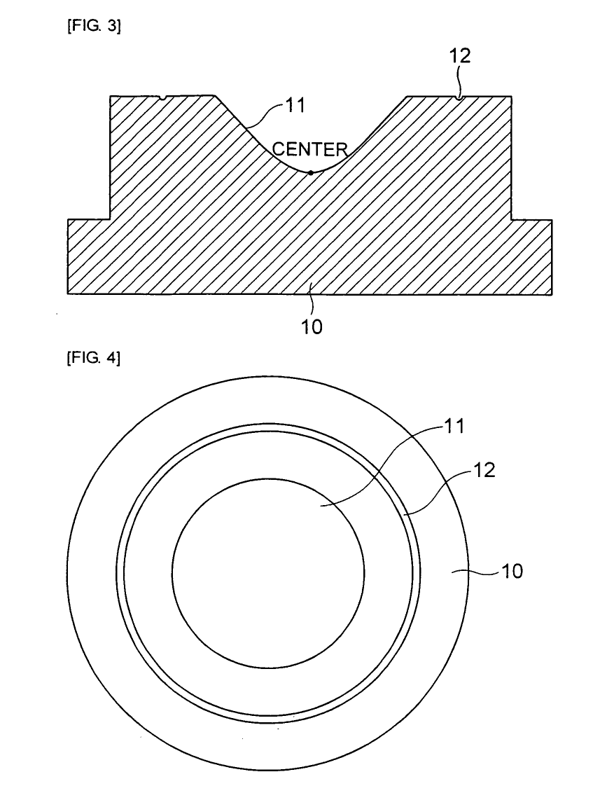

FIG. 3 is a cross-sectional view of a mold which is adopted in a wafer lens aligning method according to the invention. FIG. 4 is a plan view of the mold of FIG. 3.

As shown in the drawings, the lens mold 100 adopted in the wafer lens aligning method according to the invention has a lens forming portion 11, into which polymer-based resin is injected to mold a lens and which is formed in the central portion thereof, and a circular groove 12 formed around the lens forming portion 11.

The depth of the lens forming portion 11 is determined depending on the height of a designed lens which is to be formed on one surface of a wafer. Since the resin is transformed from the lens forming portion 11 to form the lens, micro-processing should be achieved.

The groove 12 formed around the lens forming portion 11 is formed in a concentric shape with the lens forming portion 11 such that the center of the groove 12 coincides with that of the lens forming portion 11.

Typically, the groove 12 is formed by a method of processing a rotating body using a diamond turning machine (DTM). Therefore, the groove 12 can be formed in a circle having the same center as that of the lens forming portion 11.

Although it will be described below, the center of the lens forming portion 11 and the center of a lens formation position can be caused to coincide with each other by adjusting a distance between a minute pattern of a wafer and the groove 12.

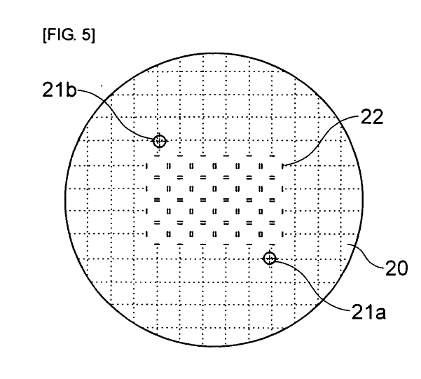

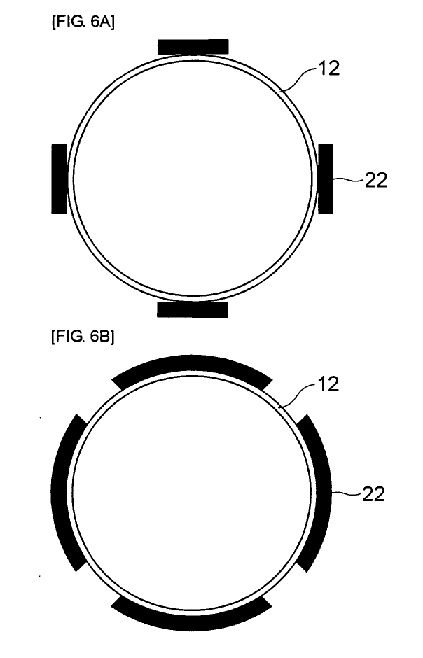

FIG. 5 is a plan view of a wafer adopted in the wafer lens aligning method according to the invention. FIGS. 6A and 6B are schematic views showing a state where minute patterns formed on a wafer and the groove of the lens mold are aligned with each other.

As shown in FIG. 5, a wafer 20 adopted in the wafer aligning method according to the invention has two types of patterns 21 (21a and 21b) and 22 formed on one surface thereof.

One type includes position recognition patterns 21a and 21b for setting an initial position after the wafer 20 is loaded by an automated equipment, and the other type includes a plurality of minute patterns 22 for alignment between a lens formation position of the wafer and the lens mold 10 after the initial position of the wafer 20 is set.

The position recognition patterns 21a and 21b can be formed at two or more arbitrary positions including the center of the wafer 20. The automated equipment first scans one position recognition pattern 21a between the two position recognition patterns 21a and 21b and stores the position thereof. Then, the automated equipment scans the other position recognition pattern 21b and stores the position thereof.

After the wafer 20 is loaded, a semiconductor equipment having the wafer 20 mounted thereon calculates the rotation angles of the searched position recognition patterns 21a and 21b and then sets a coordinate system in accordance with the loaded position of the wafer 20.

The position recognition patterns 21a and 21b formed on the wafer 20 may be constructed in a dot shape, a cross shape, a circular shape or the like. Further, the position recognition patterns 21a and 21b may be constructed in a specific shape of mark for position recognition.

In this case, if a fixed coordinate system is used in the semiconductor equipment because of a program or a different reason, the wafer 20 can be moved onto the fixed coordinate system such that the coordinate system can be set on the wafer 20, after the rotation angles of the searched position recognition patterns 21a and 21b are calculated.

In the wafer 20 of which the initial position is set by the position recognition patterns 21a and 21b, the lens mold 10 is caused to coincide with the coordinates of the lens formation position of the wafer by the plurality of minutes patterns 22 arranged in array on one surface of the wafer.

That is, the center among the minute patterns 22 formed on the wafer 20 is caused to coincide with the center of the lens mold 10 which is attached to form a lens in the position where the minute patterns 22 are formed. Then, the coordinate system of the wafer is caused to coincide with the coordinate system of the lens mold 10.

As the minute patterns 22 of the wafer 20 and the coordinate system of the lens mold 10 are caused to coincide with each other, the minute patterns 22 of the wafer 20 are aligned with the groove 12 formed on the top surface of the lens mold 10, as shown in FIGS. 6A and 6B, such that the lens can be molded in an accurate position.

As shown in FIGS. 6A and 6B, the minute patterns 22 arranged on the wafer 20 are positioned outside the groove 12 formed around the lens forming portion 11 of the lens mold 10. Therefore, as the minute patterns 22 are closely attached to the outside of the groove 12 or spaced at a predetermined distance from the groove 12, the lens mold 10 is aligned with the lens formation position of the wafer 20.

Preferably, the minute patterns 22 are formed of metal. Further, the minute patterns 22 may be formed in a linear shape so as to be symmetrical with each other or may be formed in a circular arc shape having an approximate curvature to the groove 12.

The minute patterns 22 are disposed outside the groove 12 formed on the lens mold 10, and the alignment between the wafer 20 and the lens mold 10 is achieved by adjusting a distance between the minute patterns 22 and the groove 12. In some cases, however, the minute patterns 22 may be formed so as to be positioned inside the groove 12.

FIG. 7 is a flow chart showing a wafer lens aligning method according to the invention. The wafer lens aligning method is performed as follows. First, a lens mold 10 having a lens forming portion 11 and a groove 12 formed around the lens forming portion 11 is mounted on an automated equipment (step S101). Then, a wafer 20 is mounted, in which position recognition patterns 21a and 21b are formed at arbitrary positions thereof and a plurality of minute patterns 22 are formed in array at lens formation positions (step ST102).

Next, the wafer 20 is loaded into a semiconductor equipment to scan the position recognition patterns 21a and 21b formed on the wafer 20, and a coordinate system of the wafer 20 is then set (step ST103).

At this time, the coordinate system of the wafer 20 is set so as to set the initial position of the wafer 20 in the automated equipment. The setting of the coordinate system for setting the initial position is performed as follows. One position recognition pattern 21a between the two position recognition patters 21a and 21b formed on the wafer 20 is first scanned, and the position thereof is stored. Then, the other position recognition pattern 21b of the wafer 20 is scanned, and the position thereof is stored. On the basis of the position recognition patterns 21a and 21b of which the positions are stored, the coordinate system of the semiconductor equipment is moved to set the initial position of the wafer 20.

Then, when the initial position of the wafer 20 is set, the coordinate system of the wafer 20 is caused to coincide with the coordinate system of the lens mold 10 (step ST104).

Subsequently, the center among the minute patterns 22 formed on the wafer is caused to coincide with the center of the groove 12 of the lens mold 10 such that the lens mold 10 is aligned with a lens formation position of the wafer 20.

At this time, the minute patterns 22 are positioned outside or inside the groove 12 formed in the lens mold 10, and the distance between the minute patterns 22 and the groove 12 is recognized by a control program. Then, the distance between the minute patterns 22 and the groove 12 is uniformly maintained, so that the center among the minute patterns 22 is caused to coincide with the center of the lens mold 10.

Finally, after the lens mold 10 is aligned with the lens formation position of the wafer 20, resin injected into the lens forming portion 11 of the lens mold 10 is cured by ultraviolet (UV) light such that a master lens for manufacturing a wafer lens is molded on one surface of the wafer 20 (step S106).

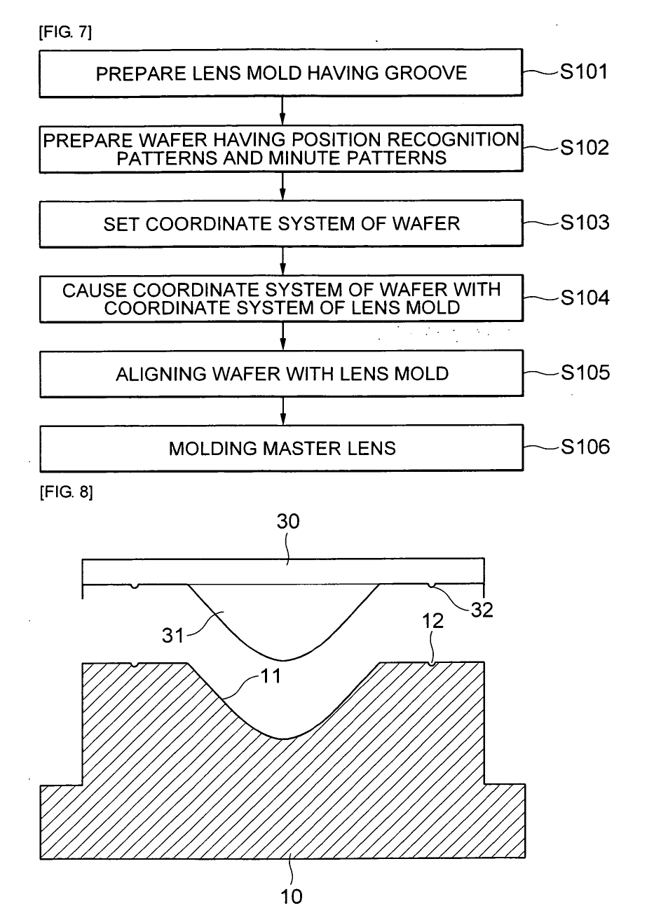

FIG. 8 is a cross-sectional view of a lens manufactured by the wafer lens aligning method according to the invention. As shown in FIG. 8, a lens 30 separated from the lens mold 10 has a projection 32 formed with a predetermined height around an optical portion 31 projecting in a semi-circular shape on a bonding surface of the lens mold 10.

The projection 32 is formed in a height corresponding to the depth of the groove by transferring resin through the groove 12 formed in the lens mold 10.

When a single wafer lens is finalized, decenter can be measured on the basis of the projection 32 formed around the optical portion 31 of the lens 30.

According to the present invention, the coordinate system of wafer is set by the position recognition patterns formed on the wafer, the mold is moved in accordance with the set coordinate system, and the minute patterns formed on the wafer are caused to coincide with the groove formed on the mold such that the lens mold can be accurately aligned with a lens formation position. Therefore, an alignment error of the mold is minimized during the manufacturing of the wafer lens, which makes it possible to significantly reduce defective products. Further, as the alignment between the lens mold and the wafer is achieved by the automated equipment, mass production can be achieved, and alignment speed can be enhanced, which makes it possible to increase productivity.

Further, although foreign matters are attached to the groove formed on the lens mold or the groove is scratched, it does not have an effect because the center of the minute patterns on the wafer is aligned with the center of the groove. Therefore, it is possible to expand the lifespan of the mold.

Furthermore, as the projection is formed on one surface of the wafer lens after the wafer and the lens mold are aligned, it is possible to measure decenter through the projection.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A wafer lens aligning method comprising the steps of:
preparing a lens mold that has a lens forming portion formed in the central portion thereof and a groove formed around the lens forming portion;
preparing a wafer that has two or more position recognition patterns formed at arbitrary positions thereof and a plurality of minute patterns formed in array at lens formation positions;
loading the wafer, searching the position recognition patterns, and setting a coordinate system;
causing the coordinate system of the wafer to coincide with the coordinate system of the lens mold;
causing the center among the minute patterns formed on the wafer to coincide with the center of the lens mold so as to align the wafer with the lens mold; and
forming a master lens in the lens formation positions arranged on the wafer.

2. The wafer lens aligning method according to claim 1, wherein polymer-based resin for molding a lens is injected into the lens forming portion formed in the central portion of the lens mold, and the mold is closely contacted with the lens formation position of the wafer.

3. The wafer lens aligning method according to claim 1, wherein the position recognition patterns are formed in a dot shape, a cross shape, or a circular shape.

4. The wafer lens aligning method according to claim 1, wherein the minute patterns are formed of metal.

5. The wafer lens aligning method according to claim 4, wherein the minute patterns are formed in a linear shape so as to be spaced at a predetermined distance from the groove, the minute patterns being symmetrical with each other.

6. The wafer lens aligning method according to claim 4, wherein the minute patterns are formed in a circular arc having an approximate curvature to the circumference of the groove.

7. A wafer lens manufactured by the wafer lens aligning method according to claim 1.

8. The wafer lens according to claim 8, wherein the wafer lens has a projection formed on the surface thereof corresponding to the top surface of the lens mold, the projection being formed by transferring resin into the groove.
